(19) United States
(12) Patent Application Publication
(10) Pub. No.: US 2010/0079629 A1
(43) Pub. Date: Apr. 1, 2010

(54) APPARATUS AND METHOD FOR CORRECTING DEFECTIVE PIXEL

(75) Inventors: Min-Kyu PARK, Seoul (KR); Jin-Min Bang, Yongin-si (KR); Hee-Chan Park, Yongin-si (KR); Jin-Ho Kim, Seoul (KR); Ji-Hye Kim, Goyang-si (KR); Yun-Je Oh, Seongnam-si (KR); Sung-Dae Cho, Yongin-si (KR)

Correspondence Address: THE FARRELL LAW FIRM, LLP, 290 Broadhollow Road, Suite 210E, Melville, NY, 11747, US

(73) Assignee: SAMSUNG ELECTRONICS CO., LTD., Suwon-si (KR)

(21) Appl. No.: 12/570,839

(22) Filed: Sep. 30, 2009

(30) Foreign Application Priority Data
Oct. 1, 2008 (KR) 10-2008-0096622

(51) Int. Cl. H04N 5/222

(52) U.S. Cl. 348/246; 348/E05.022

(57) ABSTRACT

Disclosed is an apparatus for correcting a value of a defective pixel based on values of neighboring pixels of the defective pixel, the apparatus includes a plurality of first-stage median filters for receiving a value of a target pixel and values of neighboring pixels of the target pixel, and outputting median values of the received values; and at least one second-stage median filter for receiving the value of the target pixel and the median values from the first-stage median filters, and outputting a median value of the values received by the second-stage median filter.

### PRIORITY

This application claims priority under 35 U.S.C. §119(e) to an application entitled “Apparatus and Method for Correcting Defective Pixel” filed in the Korean Industrial Property Office on Oct. 1, 2008 and assigned Serial No. 10-2008-0096622, the contents of which are hereby incorporated by reference.

### BACKGROUND OF THE INVENTION

1. Field of the Invention

The present invention relates to an apparatus and method for correcting a defective pixel in an image output from an image sensor, and more particularly to an apparatus and method for correcting a defective pixel by means of a median filter.

2. Description of the Related Art

In general, since it is difficult to manufacture an image sensor, such as a Complementary Metal-Oxide Semiconductor (CMOS) image sensor, a Charge-Coupled Device (CCD) image sensor, and the like, so that all the component pixels can have uniform characteristics, it is easy to include a defective pixel in the image sensor. Such a defective pixel is processed by software to correct the value of the defective pixel in an image which is output from the image sensor.

A defective pixel in an image may be modeled as Laplacian noise, and be corrected through the use of one of the following three methods.

A first method is to calculate the mean of the values of pixels located in a window of a predetermined size by means of a mean filter, and to replace the value of the defective pixel with the calculated mean value, thereby removing the high-frequency component of the image. The window indicates a partial region of an image. In the first method, since the defective pixel has the Laplacian noise characteristic, there are problems in that it is difficult to correct the defective pixel, and the high-frequency components for the image are damaged.

A second method is to arrange the values of pixels, which are located in a window of a predetermined size, in order of magnitude by means of a median filter, and to replace the value of a defective pixel with the median value of the arranged pixel values. The second method is effective in removing Laplacian noise, and has an advantage in that the edge components of an image are well preserved. However, the second method has a problem in that thin edge components are recognized to be noise and are damaged.

A third method is performed by means of a weighted mean filter. The third method may be expressed by Equation (1):

$$out [ r ] [ c ] = mean [ r ] [ c ] + \frac{var ( in [ r ] [ c ] )}{var\_noise + var ( in [ r ] [ c ] )} ( in [ r ] [ c ] - mean [ r ] [ c ] ) \qquad ( 1 )$$

In Equation (1), “in” and “out” represent input brightness and output brightness, respectively, “r” and “c” represent row coordinates and column coordinates in an image, respectively, “mean[r][c]” represents the mean value of an {r, c} position, “var(in[r][c])” represents variance of an {r, c} position, and “var_noise” represents variance of noise.

When the noise variance “var_noise” is greater than the signal variance “var(in[r][c]),” “var(in[r][c])/(var_noise+var(in[r][c]))” approaches zero, so that the output “out[r][c]” approaches the mean “mean[r][c],” and noise is removed. In contrast, when the signal variance is greater than the noise variance, as in an edge region, “var(in[r][c])/(var_noise+var(in[r][c]))” approaches one, so that the output “out[r][c]” approaches the input “in[r][c],” and noise is not removed.

Such a method requires the accurate modeling of noise to be performed ahead of the method. However, since noise variance is determined based on the characteristics of an image sensor and ambient brightness, and is influenced by the exposure time of a camera, the integration time of an image sensor, and so on, and thus it is very difficult to accurately model noise variance.

Except for the method for correcting a defective pixel by means of a median filter, the other methods require a process of identifying the location of a defective pixel.

Korean Patent Laid-Open Publication No. 10-2007-98263, invented by Kim Sang-Ok and entitled “Apparatus and Method for Correcting Defective Pixel” discloses a defective pixel correction apparatus including: a threshold value determination unit for generating a signal change rate by accumulating changes of a signal based on a previous image, and determining a threshold value by applying the generated signal change rate; a defective pixel detection unit for comparing the numerical difference between a determination-targeted pixel and an adjacent pixel thereof with the determined threshold value, and detecting a defective pixel based on the comparison result; and a defective pixel correction unit for correcting the value of the detected defective pixel when the defective pixel has been detected. In addition, Korean Patent Laid-Open Publication No. 10-2007-98263 adopts the aforementioned method using a mean filter, as a defective pixel correction method.

As described above, the conventional defective pixel correction methods using a mean filter have problems in that a heavy burden is caused in terms of hardware and software because it is necessary to accurately identify the location of a defective pixel, and that information on noise must be accurately identified.

Meanwhile, in the conventional defective pixel correction method using a median filter, although not required to accurately identify the location of a defective pixel, a problem exists in that the original signal is damaged.

### SUMMARY OF THE INVENTION

Accordingly, the present invention has been made to solve the above-mentioned problems occurring in the prior art, and the present invention provides an apparatus and method for accurately correcting a defective pixel without damaging the original signal, even without requiring a procedure of identifying the location of the defective pixel.

In accordance with an aspect of the present invention, there is provided an apparatus for correcting a value of a defective pixel based on values of neighboring pixels of the defective pixel, the apparatus includes a plurality of first-stage median filters for receiving a value of a target pixel and values of neighboring pixels of the target pixel, and outputting median values of the received values; and at least one second-stage median filter for receiving the value of the target pixel and the median values from the first-stage median filters, and outputting a median value of the values received by the second-stage median filter.

In accordance with another aspect of the present invention, there is provided a method for correcting a value of a defective pixel based on values of neighboring pixels of the defective pixel, the method includes sampling a value of a target pixel and values of neighboring pixels of the target pixel; calculating temporary median values of the sampled values; deriving a final median value from the value of the target pixel and the temporary median values; and substituting the value of the target pixel with the final median value.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram illustrating the configuration of a defective pixel correction apparatus according to an embodiment of the present invention;

FIG. 2 is a diagram illustrating a part of an image sensor shown in FIG. 1;

FIGS. 3A to 3D are diagram illustrating the configurations of various Bayer color filters using a 5×5 window size;

FIGS. 4A and 4B are diagram illustrating the coordinate disposition and color disposition of a 5×5 window processed by the sampler shown in FIG. 1; and

FIG. 5 is a diagram illustrating a black and white edge image of a 5×5 window.

### DETAILED DESCRIPTION OF THE EXEMPLARY EMBODIMENT

Hereinafter, embodiments of the present invention will be described with reference to the accompanying drawings. In the following description of the present invention, a detailed description of known functions and configurations incorporated herein will be omitted when it may make the subject matter of the present invention rather unclear.

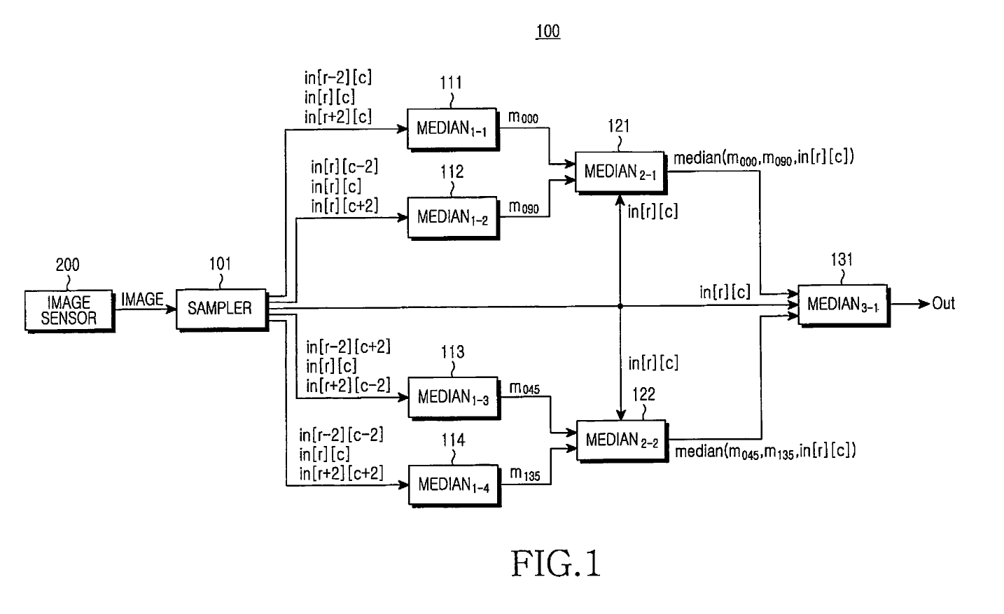

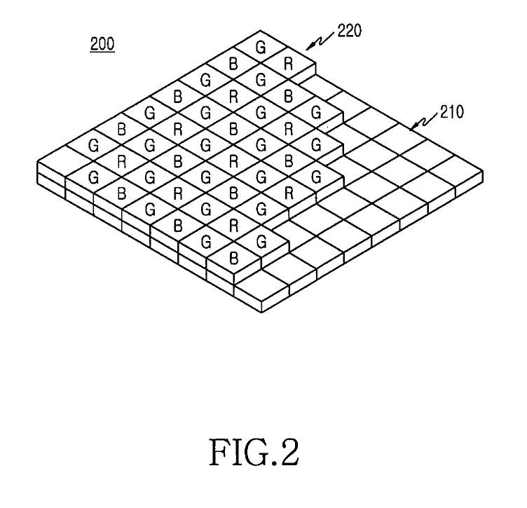

FIG. 1 is a block diagram illustrating the configuration of a defective pixel correction apparatus according to an embodiment of the present invention, and FIG. 2 is a diagram illustrating a part of an image sensor. The defective pixel correction apparatus 100 includes a sampler 101 and a plurality of median filters 111 to 131 connected in a hierarchical tree structure.

The sampler 101 samples the values of pixels in a window of a predetermined size from an image input from an image sensor 200, and outputs the sampled pixel values to the median filters 111 to 131.

The image sensor 200 includes a pixel array 210 in a matrix structure, and each pixel 210 outputs a value corresponding to the brightness of incident light. Although an image sensor may be configured in such a manner that each pixel detect red, green, and blue, however because of the high cost of this technique, generally an image sensor is configured in such a manner that each pixel use only one color through the use of a color filter. The image sensor 200 may further include a Bayer color filter 220 disposed on the pixel array 210. The Bayer color filter 220 includes filter units of three colors, i.e. Red (R), Green (G), and Blue (B), wherein filter units of each color are disposed at intervals of one pixel in both row and column directions. In addition, the filter units correspond on a one-to-one basis to the pixels 210. For example, light passing through an R filter unit has red, and a pixel arranged to correspond to the R filter unit detects red light.

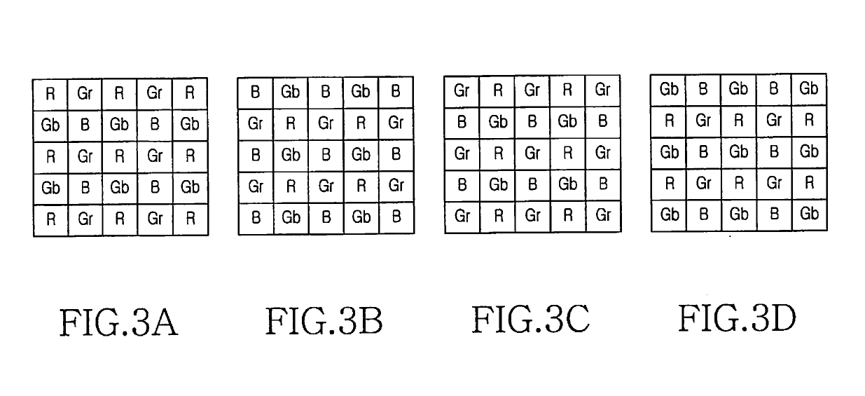

FIGS. 3A to 3D are diagrams illustrating the configurations of various Bayer color filters using a 5×5 window size. FIG. 3A illustrates a Bayer color filter where an R filter unit is disposed at the window center, i.e. at the third row and the third column, FIG. 3B illustrates a Bayer color filter where a B filter unit is disposed at the window center, FIG. 3C illustrates a Bayer color filter where a Gr filter unit is disposed at the window center, and FIG. 3D illustrates a Bayer color filter where a Gb filter unit is disposed at the window center. The Gr filter unit represents a G filter unit, at both sides of which in the row direction R filter units are disposed, and the Gb filter unit represents a G filter unit, at both sides of which in the row direction B filter units are disposed.

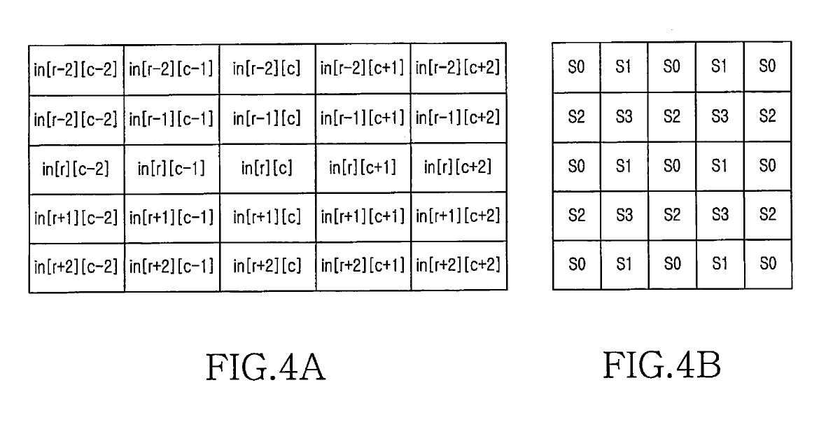

FIGS. 4A and 4B are diagrams illustrating the coordinate disposition and color disposition of a 5×5 window processed by the sampler 101. When the coordinates of a target pixel, which is the defective pixel to be corrected, are {r, c}, coordinates are disposed as shown in FIG. 4A. For example, the value of a pixel positioned at the first row and third column in the window is expressed as “in[r−2][c].” FIG. 4B illustrates the disposition of color in the window, wherein S0, S1, S2 and S3 represent the colors of pixels. For example, when the color of a target pixel is “R,” the S0, S1, S2 and S3 correspond to R, Gr, Gb, and B, respectively.

The median filters 111 to 131 are connected in a hierarchical tree structure such that median filters in a lower stage are connected to a median filter in a higher stage. In this case, the higher and the lower are distinguished based on an input/output direction, i.e. based on the direction of signal transmission. The plurality of median filters 111 to 131 are connected in a three-stage hierarchical tree structure, wherein the first stage, the lowest stage, includes four median filters 111 to 114; the second stage, the intermediate stage, includes two median filters 121 and 122; and the third stage, the highest stage, includes one median filter 131. Hereinafter, a first median filter in an N^{th} stage will be designated as an (N−1)^{st} median filter. The number of median filters included in the lowest stage is determined based on the number of sampling axes (or sampling directions) centered at a target pixel. An embodiment of the present invention shows a case where four sampling axes are used, i.e. where sampling axes at 0 degree, 45 degree, 90 degree, and 135 degree with respect to a column direction are used. Here, the angles of sampling axes are only an example, and in addition, it is not necessary for each sample axis to be a straight line.

The sampler 101 provides each median filter 111 to 114 in the first stage with three pixel values of the same color belonging to a corresponding sampling axis, and provides every median filter 111 to 131, including the median filters 111 to 114 in the first stage, with the value of a target pixel. That is, the sampler 101 provides the (1-1)^{st} median filter 111 with same-color pixel values of the third column belonging to the sampling axis of 0 degree, i.e. with the first-row, third-row, and fifth-row pixel values of the third column. The sampler 101 provides the (1-2)^{nd} median filter 112 with same-color pixel values of the third row belonging to the sampling axis of 90 degree, i.e. with the first-column, third-column, and fifth-column pixel values of the third row. The sampler 101 provides the (1-3)^{rd} median filter 113 with same-color pixel values belonging to the sampling axis of 45 degree, i.e. with the pixel values of the first row and fifth column, the third row and third column, and the fifth row and first column. The sampler 101 provides the (1-4)^{th} median filter 114 with same-color pixel values belonging to the sampling axis of 135 degree, i.e. with the pixel values of the first row and first column, the third row and third column, and the fifth row and fifth column.

Each of the first-stage median filters 111 to 114 arranges the input pixel values in order of magnitude, and outputs a temporary median value of the arranged pixel values. Equation (2) expresses temporary median values “m_{axis-angle}” output from the first-stage median filters 111 to 114.

m₀₀₀=median(in[r−2][c],in[r][c],in[r+2][c])

m₀₄₅=median(in[r−2][c+2],in[r][c],in[r+2][c−2])

m₀₉₀=median(in[r][c−2],in[r][c],in[r][c+2])

m₁₃₅=median(in[r−2][c−2],in[r][c],in[r+2][c+2]) (2)

Each second-stage median filter 121 or 122 receives median values from first-stage median filters connected to the second-stage median filter, receives the target pixel value from the sampler 101, arranges the received values in order of magnitude, and outputs a median value of the arranged values. That is, the (2-1)^{st} median filter 121 receives median value “m₀₀₀” from the (1-1)^{st} median filter 111, median value “m₀₉₀” from the (1-2)^{nd} median filter 112, and target pixel value “in[r][c]” from the sampler 101, and then outputs a median value among “m₀₀₀,” “m₀₉₀,” and “in[r][c].” The (2-2)^{nd} median filter 122 receives median value “m₀₄₅” from the (1-3)^{rd} median filter 113, median value “m₁₃₅” from the (1-4)^{th} median filter 114, and target pixel value “in[r][c]” from the sampler 101, and then outputs a median value among “m₀₄₅,” “m₁₃₅,” and “in[r][c].”

The third-stage median filter 131 receives median values from second-stage median filters 121 and 122 connected to the third-stage median filter, receives the target pixel value from the sampler 101, arranges the received values in order of magnitude, and outputs a temporary median value of the arranged values. That is, the (3-1)^{st} median filter 131 receives median value “median(m₀₀₀, m₀₉₀, in[r][c])” from the (2-1)^{st} median filter 121, median value “median(m₀₄₅, m₁₃₅, in[r][c])” from the (2-2)^{nd} median filter 122, and target pixel value “in[r][c]” from the sampler 101, and then outputs a median value among “median(m₀₀₀, m₀₉₀, in[r][c]),” “median(m₀₄₅, m₁₃₅, in[r][c]),” and “in[r][c].”

Equation (3) expresses the final median value “out” output from the third-stage median filter 131:

out=median(median(m₀₀₀,m₀₉₀,in[r][c]),median(m₀₄₅,m₁₃₅,in[r][c]),in[r][c]) (3)

Hereinafter, an example where the defective pixel correction method according to the present invention is applied to an edge image will be described in comparison with the conventional defective pixel correction method using a median filter.

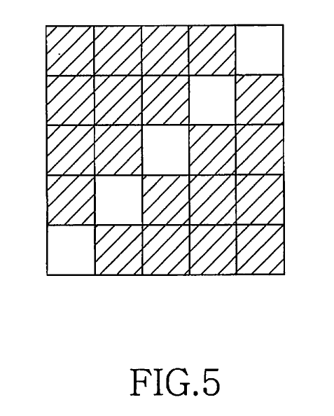

FIG. 5 is a diagram illustrating a black and white edge image of a 5×5 window. FIG. 5 shows an edge image which has the form of a white diagonal line from the first row and fifth column to the fifth row and first column on the black background. It is assumed that the brightness of black is defined as “0,” the brightness of white is defined as “255,” and a pixel on the third row and third column is a target pixel to be corrected.

The conventional defective pixel correction method using a median filter uses Equation (4):

$$out = median ( \begin{matrix}in [ r - 2 ] [ c - 2 ] , in [ r - 2 ] [ c ] , in [ r - 2 ] [ c + 2 ] , \\ in [ r ] [ c - 2 ] in [ r ] [ c ] , in [ r ] [ c + 2 ] , \\ in [ r + 2 ] [ c - 2 ] , in [ r + 2 ] [ c ] , in [ r + 2 ] [ c + 2 ]\end{matrix} ) \qquad ( 4 )$$

When numerals corresponding to the black and white edge image is substituted into Equation (4), the result of the substitution is shown in Equation (5):

out=median(0,0,255,0,255,0,255,0,0)=0 (5)

That is, a value resulting from the conventional defective pixel correction method using a median filter is zero, so that the original image is damaged.

In contrast, when numerals corresponding to the black and white edge image is substituted into Equation (2), the result of the substitution is shown in Equation (6):

m₀₀₀=median(in[r−2][c],in[r][c],in[r+2][c])=median(0,255,0)=0

m₀₄₅=median(in[r−2][c+2],in[r][c],in[r+2][c−2])=median(255,255,255)=255

m₀₉₀=median(in[r][c−2],in[r][c],in[r][c+2])=median(0,255,0)=0

m₁₃₅=median(in[r−2][c−2],in[r][c],in[r+2][c+2])=median(0,255,0)=0 (6)

When the temporary median values in Equation (6) is applied to Equation (3), the following result, shown in Equation (7), is obtained:

$$\begin{matrix}out = median ( median ( {m}_{000} , {m}_{090} , in [ r ] [ c ] ) , \\ median ( {m}_{045} , {m}_{135} , in [ r ] [ c ] ) , in [ r ] [ c ] ) \\ = median ( median ( 0 , 0 , 255 ) , \\ median ( 255 , 0 , 255 ) , 255 ) \\ = median ( 0 , 255 , 255 ) \\ = 255\end{matrix} \qquad ( 7 )$$

That is, according to the defective pixel correction method of the present invention, the final median value of 255 is obtained, so that the original image is preserved.

Since the defective pixel correction apparatus and method according to the present invention corrects a defective pixel by means of multi-stage median filters in the hierarchical tree structure, it is possible to accurately correct the defective pixel without damaging the original signal, even without requiring a procedure of identifying the position of the defective pixel.

It is clear that the defective pixel correction apparatus or method according to the present invention may be implemented by hardware, software (i.e. a program), or a combination of both. Such a program may be stored in a volatile or nonvolatile recording medium which can be read by a machine, such as a computer. The recording medium includes a storage device, such as a ROM and the like, memory, such as a RAM, a memory chip, an integrated circuit, and the like, and an optical or magnetic recording medium, such as a CD, a DVD, a magnetic disk, a magnetic tape, and the like. That is, the defective pixel correction method according to the present invention may be implemented in the form of a program which includes code for achieving the method. Further, such a program may be transferred electrically through a medium, just as a communication signal propagated by wire or wirelessly, the equivalents of which are also included in the scope of the present invention.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An apparatus for correcting a value of a defective pixel based on values of neighboring pixels of the defective pixel, the apparatus comprising:
a plurality of first-stage median filters for receiving a value of a target pixel and values of neighboring pixels of the target pixel, and outputting median values of the received values; and
at least one second-stage median filter for receiving the value of the target pixel and the median values from the first-stage median filters, and outputting a median value of the values received by the second-stage median filter.

2. The apparatus as claimed in claim 1, further comprising a sampler for outputting the target pixel value and the neighboring pixel values, which are located on sampling axes centered at the target pixel, to the first-stage median filters.

3. The apparatus as claimed in claim 1, further comprising a plurality of second-stage median filters connected to the first-stage median filters on a one-to-multiple basis; and
at least one third-stage median filter connected to the second-stage median filters on a one-to-multiple correspondence, the third-stage median filter receiving the value of the target pixel and median values from the second-stage median filters, the third-stage median filter outputting a median value of the values received by the third-stage median filter.

4. The apparatus as claimed in claim 3, further comprising four first-stage median filters, two second-stage median filters, and one third-stage median filter, each second-stage median filter connected to corresponding first-stage median filters on one-to-two correspondence, and the third-stage median filter is connected to the two second-stage median filters.

5. A method for correcting a value of a defective pixel based on values of neighboring pixels of the defective pixel, the method comprising the steps of:
sampling a value of a target pixel and values of neighboring pixels of the target pixel;
calculating temporary median values of the sampled values;
deriving a final median value from the value of the target pixel and the temporary median values; and
substituting the value of the target pixel with the final median value.

6. The method as claimed in claim 5, further comprising setting up a plurality of sampling axes centered at the target pixel.

7. The method as claimed in claim 6, wherein the sampling step comprises sampling the value of the target pixel and values of the neighboring pixels which are located on the sampling axes, and wherein the step of calculating the temporary median values comprises calculating a median value among the target pixel value and corresponding neighboring pixel values with respect to each sampling axis.

8. The method as claimed in claim 5, wherein the step of deriving the final median value comprises repeating a step of calculating a median value among the target pixel value and temporary median values, which have been calculated in a previous step or the step of calculating the temporary median values, until the single final median value is derived.

9. The method as claimed in claim 5, wherein each of the temporary median value and the final median value is one of the target pixel value and two neighboring pixel values, or one of the target value and two temporary median values.

10. A computer-readable recording medium in which a program for implementing a method of correcting a defective pixel based on values of neighboring pixels of the defective pixel, the method comprising the steps of:
sampling a value of a target pixel and values of neighboring pixels of the target pixel;
calculating temporary median values of the sampled values;
deriving a final median value from the value of the target pixel and the temporary median values; and
substituting the value of the target pixel with the final median value.

11. The computer-readable recording medium as claimed in claim 10, further comprising setting up a plurality of sampling axes centered at the target pixel.

12. The computer-readable recording medium as claimed in claim 11, wherein the sampling step comprises sampling the value of the target pixel and values of the neighboring pixels which are located on the sampling axes, and wherein the step of calculating the temporary median values comprises calculating a median value among the target pixel value and corresponding neighboring pixel values with respect to each sampling axis.

13. The computer-readable recording medium as claimed in claim 10, wherein the step of deriving the final median value comprises repeating a step of calculating a median value among the target pixel value and temporary median values, which have been calculated in a previous step or the step of calculating the temporary median values, until the single final median value is derived.

14. The computer-readable recording medium as claimed in claim 10, wherein each of the temporary median value and the final median value is one of the target pixel value and two neighboring pixel values, or one of the target value and two temporary median values.
